(19) United States
(12) Patent Application Publication
(10) Pub. No.: US 2007/0129656 A1
(43) Pub. Date: Jun. 7, 2007

(54) MYOFACIAL MASSAGER

(76) Inventor: William R. Brooks, Lafayette, CO (US)

Correspondence Address: GEOFFREY E. DOBBIN, PATENT ATTORNEY, 4278 SOUTH 6220 WEST, WEST VALLEY CITY, UT, 84128-6501, US

(21) Appl. No.: 11/307,197

(22) Filed: Jan. 26, 2006

Related U.S. Application Data
(60) Provisional application No. 60/593,580, filed on Jan. 26, 2005.

(51) Int. Cl. A61H 7/00

(52) U.S. Cl. 601/135; 601/137

(57) ABSTRACT

A massager is disclosed for self-treatment of myofacial trigger points. The invention may be practiced in a number of embodiments. One embodiment features an angled head on a rigid handle. The head presents a matrix of positioning holes for an assortment of massage tips. The other features a smaller head and an additional flaccid handle opposite the rigid handle. Additionally, heads may be exchanged with different handles for increased utility.

### CROSS-REFERENCES TO RELATED APPLICATIONS

The present application claims priority based on prior Provisional Application No. 60/593,580, filed Jan. 26, 2005.

### FIELD OF INVENTION

The field of the present invention is massagers and is more particularly related to self-actuated massagers designed to relax and desensitize myofacial “trigger points” for relief of pain and other symptoms.

### BACKGROUND OF THE INVENTION

Myotherapy is the treatment of myofacial pain. Specifically, it is the treatment of particular areas of increased sensitivity and tenderness in a person's muscles. This patent application makes no attempt to prove any merit or efficacy in myotherapy, but is directed to an apparatus that furthers the practice. For more information, the Applicant refers the reader to the following texts for background into the techniques and basis for the practice, and hereby incorporates them by reference:

Myotherapy: Bonnie Prudden's Complete Guide to Pain Free Living, ©1984 by Bonnie Prudden, Inc., Ballantine Books: New York.

Fibromyalgia & Chronic Myofacial Pain Syndrome: A Survival Manual, © 1996 by Devin Starlanyl, M.D. and Mary Ellen Copeland, M.S., M.A., New Harbinger Publications, Inc. Oakland, Calif.

Some massagers have been introduced for the purpose of treating myofacial pain. For example, the FENIX, seen at Internet address www.fre-inc.com is illustrative of the prior art.

While the aforementioned inventions accomplish their individual objectives, they do not describe a myotherapeutic massager with as precise a placement of therapeutic actuation as the present invention, especially when used by an individual on one's self. In this respect, the massager according to the present invention departs substantially from the usual designs in the prior art. In doing so, this invention provides a myotheraputic massager with more precise and efficient control, requiring less physical effort on the part of the user and that is also adaptive to a variety of treatment positions, including standing, sitting and reclining, options, and techniques on one's own body.

### SUMMARY OF THE INVENTION

In view of the foregoing disadvantages inherent in the known types of massagers, this invention provides an improved myotheraputic massager. As such, the present invention's general purpose is to provide a new and improved massager that will provide deep tissue force and enable a single user to reach, relax and release myofacial trigger points on that user's own body. To accomplish this purpose, the massager according to the present invention has a specially angled head with a matrix of positioning holes for the insertion and placement of massage tips. These tips are of numerous constructions and shapes, according to the purpose of the individual tips, and a number are novel and non-obvious in their own right. The massager also features both a rigid handle and a flaccid handle, which may be used in conjunction with the rigid handle so as to allow greater precision in use.

The more important features of the invention have thus been outlined in order that the more detailed description that follows may be better understood and in order that the present contribution to the art may better be appreciated. Additional features of the invention will be described hereinafter and will form the subject matter of the claims that follow.

Many objects of this invention will appear from the following description and appended claims, reference being made to the accompanying drawings forming a part of this specification wherein like reference characters designate corresponding parts in the several views.

Before explaining at least one embodiment of the invention in detail, it is to be understood that the invention is not limited in its application to the details of construction and the arrangements of the components set forth in the following description or illustrated in the drawings. The invention is capable of other embodiments and of being practiced and carried out in various ways. Also it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a perspective view of the first embodiment of the invention.

FIG. 2 is a plan view of a number of option massage tips.

FIG. 3 is a side elevation, with a partial section, of the first embodiment of the invention.

FIG. 4 is a top plan view of the first embodiment of the invention.

FIG. 5 is a perspective view of the second embodiment of the invention in use on an individual's thigh region.

FIG. 6 is a perspective view of the second embodiment of the invention in use on an individual's lower back and buttocks regions.

FIG. 7 is a perspective view of the second embodiment of the invention in use on an individual's hamstring region.

FIG. 8 is a perspective view of the second embodiment of the invention in use on an individual's upper and middle back regions.

FIG. 10 is a perspective view of the second embodiment of the invention in use on an individual's mid back region.

FIG. 11 is a perspective view of the first embodiment of the invention in use on an individual's side.

FIG. 12 is a perspective view of the second embodiment of the invention in use on an individual's outer arm region.

FIG. 13 is a perspective view of the second embodiment of the invention in use on an individual's lower back region while utilizing a chair as an external anchor.

FIG. 14 is a perspective view of the second embodiment of the invention in use on an individual's inner thigh and groin regions.

FIG. 15 is a perspective view of the first embodiment of the invention in use on an individual's upper back region.

FIG. 16 is a perspective view of the first embodiment of the invention in use on an individual's neck region.

FIG. 17 is a perspective view of the first embodiment of the invention in use on an individual's calf region.

FIG. 18 is a perspective view of the first embodiment of the invention in use on an individual's mid back region.

FIG. 19 is a perspective view of the first embodiment of the invention in use on an individual's lower back region, utilizing a chair back for additional leverage.

FIG. 20 is a perspective view of the first embodiment of the invention in use on an individual's mid back region utilizing a wall for additional leverage.

FIG. 21 is a perspective view of the first embodiment of the invention in use on an individual's foot.

FIGS. 22a-22c are a three-staged side view of the first embodiment of the invention in use on an individual's back.

### DETAILED DESCRIPTION OF THE PREFERRED EMBODIMENT

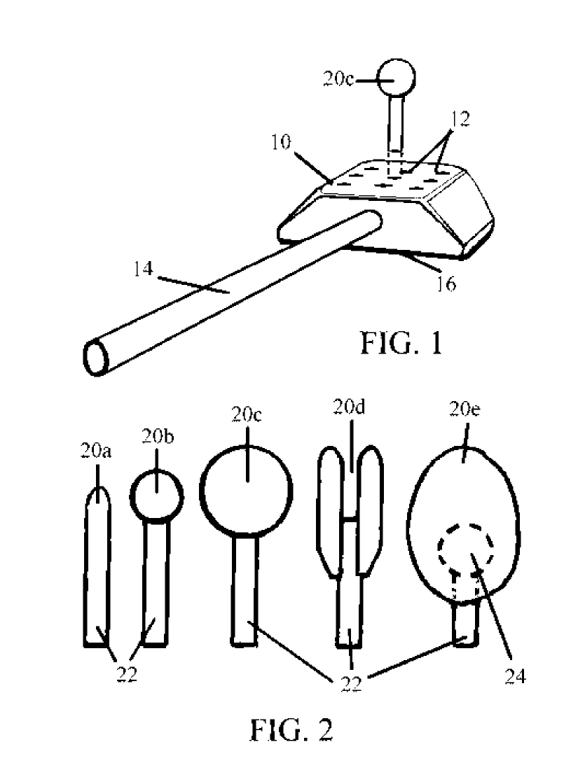

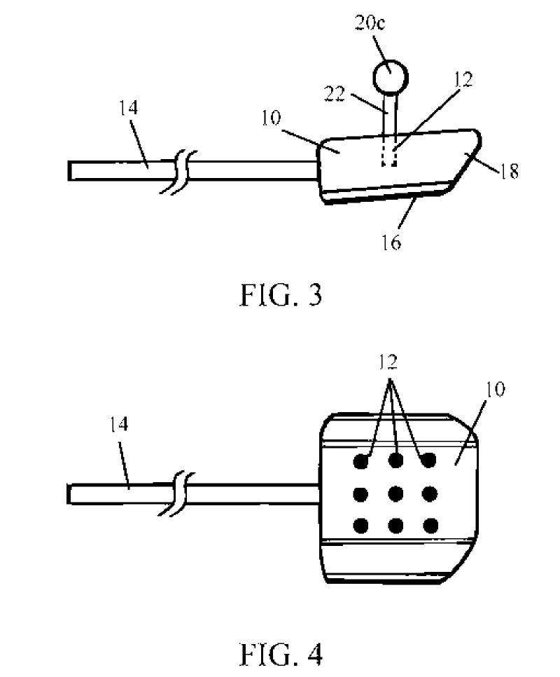

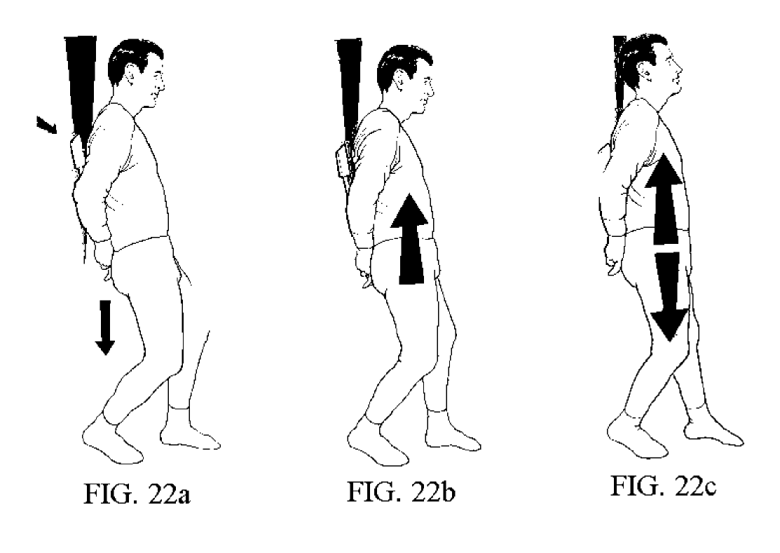

With reference now to the drawings, the preferred embodiment of the myotheraputic massager is herein described. With particular reference to FIGS. 1-4, the primary embodiment of the massager features a head 10 attached to a handle 14. On the topside of head 10 is positional matrix 12 for use with massage tips 20a-20e. Head is angled, particularly on angle side 18 to allow for various positions of use against flat, stable and firm surfaces, such as walls, beds, floors, chair backs or any other such surface, as demonstrated in FIGS. 22 and 22a-22c. Padding 16 is provided on the bottom side and the angle side 18 to increase friction against such surfaces. Padding may be a rubberized material or paint or any other surface treatment that would increase friction.

Tips 20a-20e are inserted into holes in the matrix 12 to allow for various treatment options. Tips 20a-20c are of differing thickness to account for tissue thickness when in use. Tip 20d is a specialized capture tip, with two prongs and pivoting ability, for difficult to localize trigger points and tense bands of muscle tissue. Tip 20d rotates within the positional holes in matrix 12 and, for additional efficacy; the prongs are askew from one another, facilitating rotation and capture. Likewise, tip 20d may be comprised of two smaller ball tips, such as 20b. Tip 20e is a specialized ice tip with a freezable substance, such as water, inside a capsule mounted on a tip. Other tip innovations are possible. For preferred embodiments of the tips, tips 20a and 20d should be covered with or made of an elastomeric material, such as rubber or plastic to lessen bruising potential when using these particular tips. Other tips may likewise be manufactured of any combination of rigid and elastomeric materials such as wood, plastic, rubber, or vinyl.

Other figures demonstrating the use of the first embodiment are FIGS. 15 through 22a-22c. By using rigid handle 14 as a lever and the point of contact of the massager with the surface as a fulcrum, trigger points may be reached and relaxed with minimal effort and contortion on the part of the user

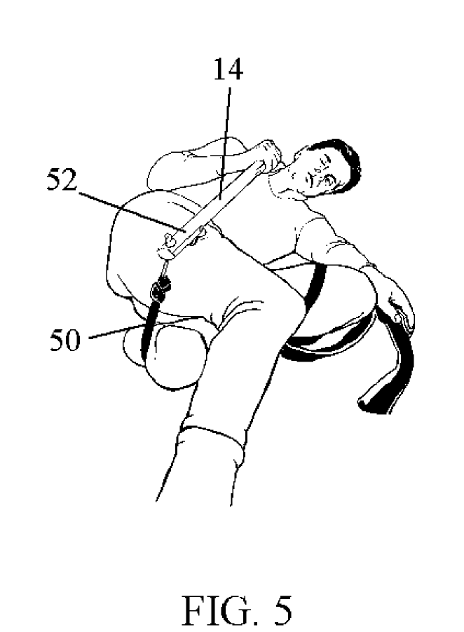

As seen in FIG. 5, the second preferred embodiment features a smaller head 52 and a secondary flaccid handle 50 opposite handle 14 that a user may use to wrap and support the massager on various objects and parts of the body, thereby replacing a firm surface for areas harder to reach while leaning upon such a surface or for when such a surface is unavailable. Head 52 may be of one piece with handle 14. Tips 20a-20e are all utilizable on the second embodiment. Use of the second embodiment is shown in FIGS. 5-14. In these figures, trigger points are represented on the user as an asterisk (*).

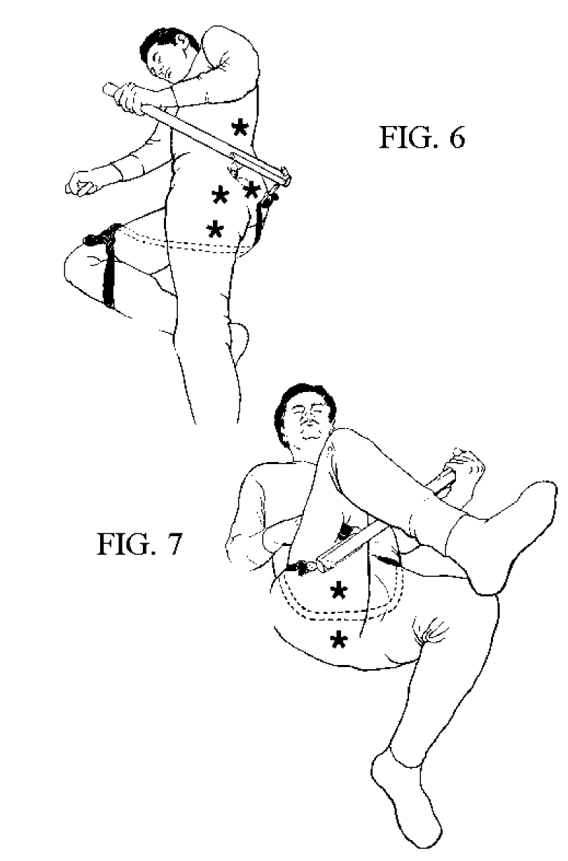

FIG. 6 depicts a user working trigger points on the lower back, outer thigh, hip and buttocks regions. The user is wraps the flaccid handle around the opposite knee as an anchor and wraps the remainder of the handle around the body to provide leverage to work the above mentioned regions. FIG. 7 depicts use on the hamstring area, where the flaccid handle is anchored around the user's waist.

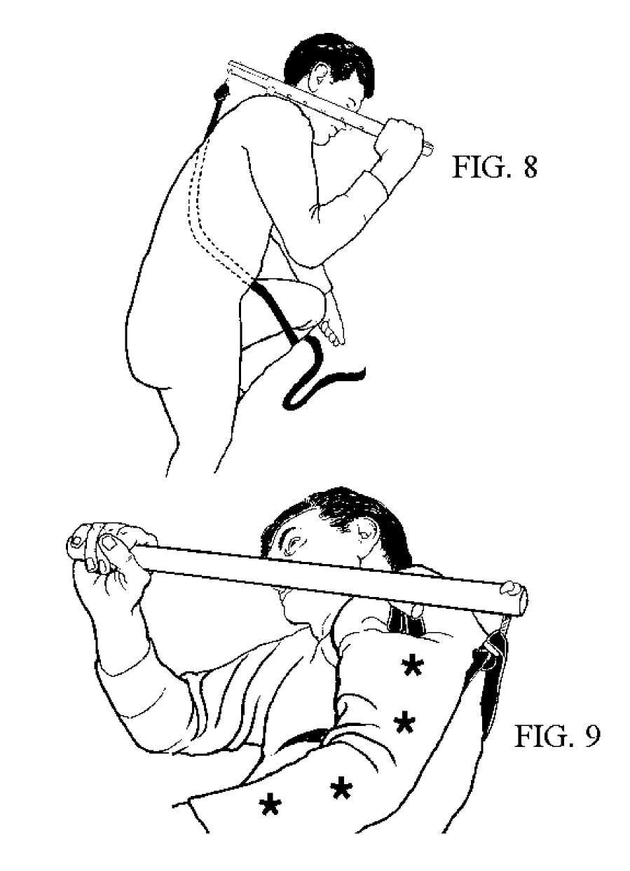

FIG. 8 depicts the use of the second embodiment on the back, particularly the mid to upper back region. FIG. 9 depicts use on the outer parts of the arm. It should be noted that in both figures, the flaccid handle is anchored on the opposite knee of the user from the worked regions. Also, in FIG. 9, the capture point 20d is being utilized.

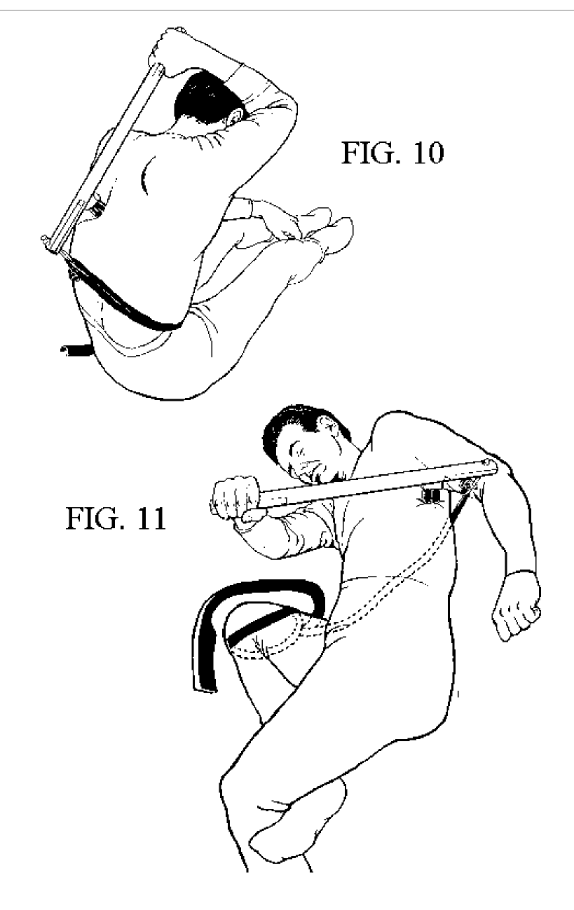

FIGS. 10 and 11 depict a user working on his mid back and side respectively. In either figure, the waist may be used as the anchor for the flaccid handle, though the knee may also be used, as shown in FIG. 11.

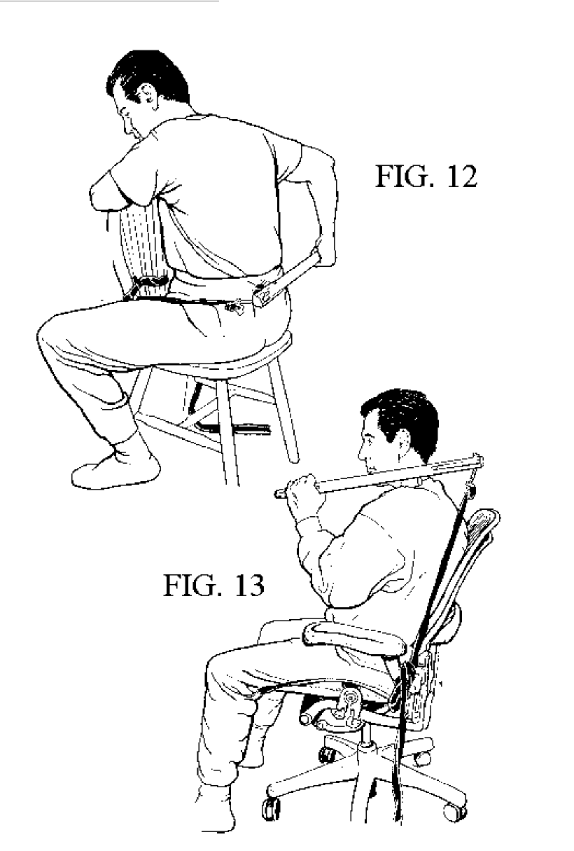

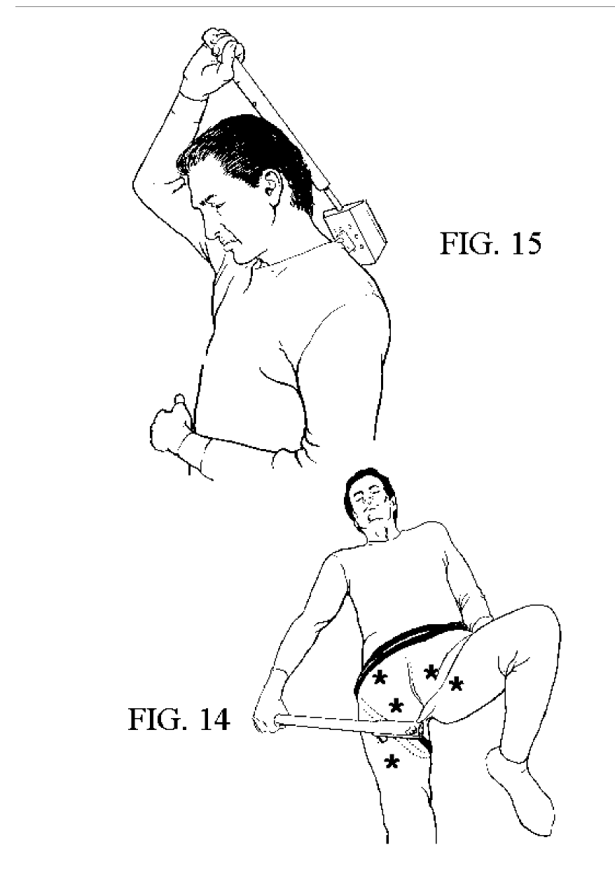

FIGS. 12 and 13 depict the use of chairs as external anchor points as a user works on the low and upper back respectively. FIG. 14 shows use in the groin area and inner thigh. In this case, the user is anchoring the flaccid strap around his waist.

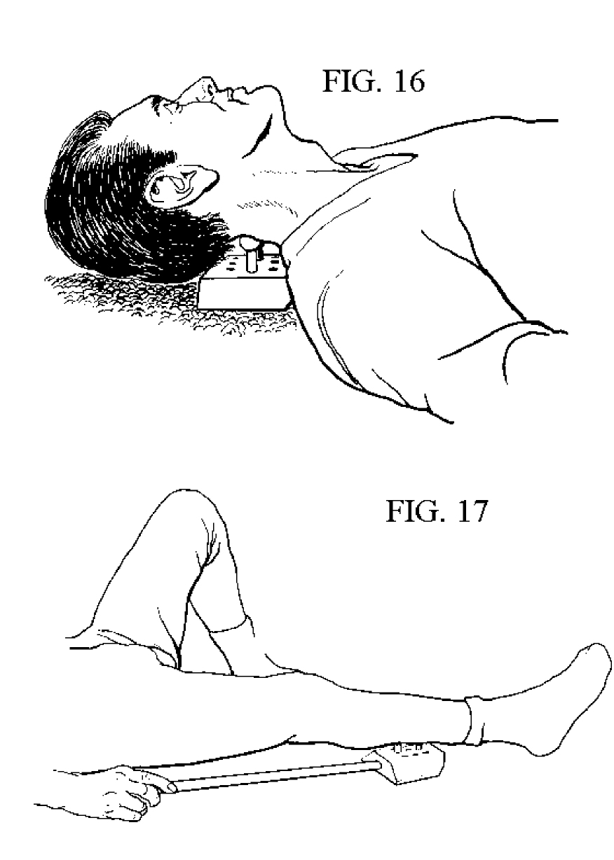

FIG. 15 depicts the use of the first embodiment, with the user bracing the head of the invention against a wall while he works the upper back. The angled side 18 is used to provide a downward pressure on the upper back. FIG. 16 depicts use on the neck and base of the head, where the user simply lies on the invention. Likewise, the user merely rests his leg on the head of the invention to treat trigger points in his calf in FIG. 17. The foot may be treated in a similar manner, as shown in FIG. 21.

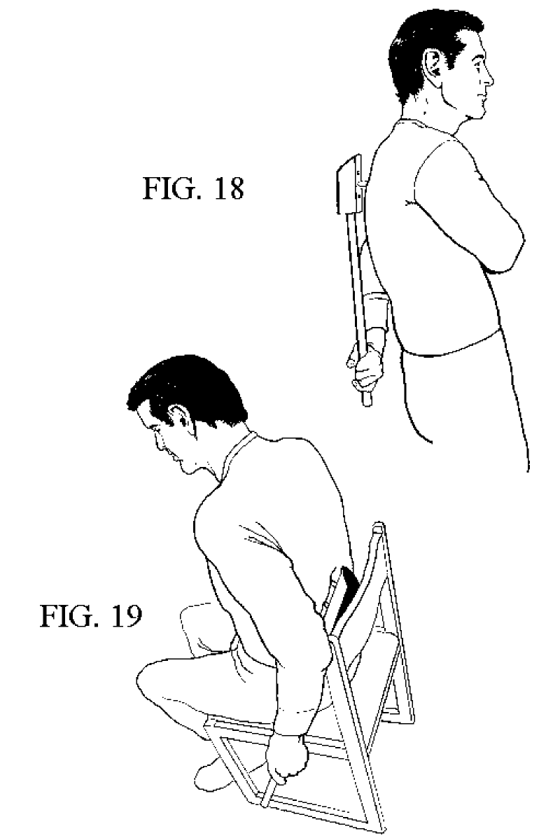

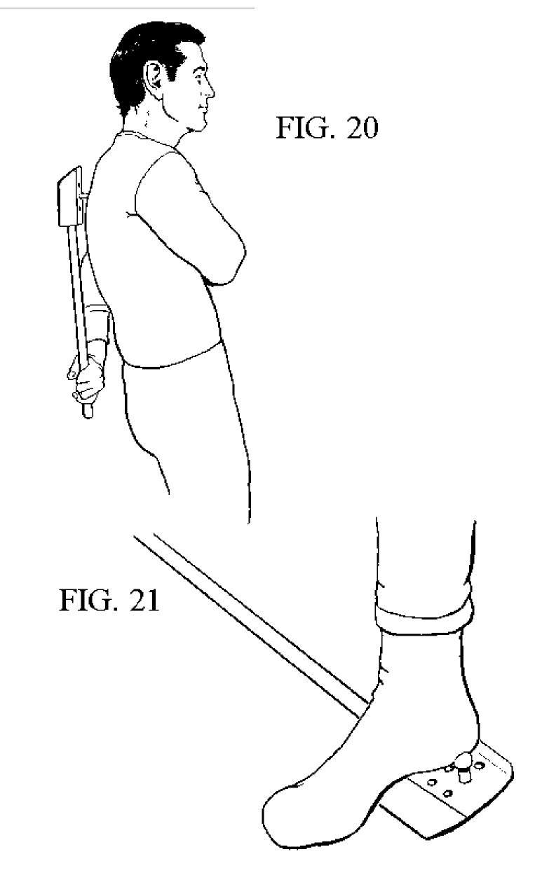

Additional leverage for working trigger points may be achieved through bracing the invention against a wall (shown in FIGS. 18 and 20) or a chair back, FIG. 19. In use, the invention may be used to simulate basic massage techniques, as depicted in FIGS. 22a-22c, where the user braces the invention against the wall and slides his body up and down, over the selected tips. Other techniques are easily duplicated with simple experimentation of anchor points and leverage.

Although the present invention has been described with reference to preferred embodiments, numerous modifications and variations can be made and still the result will come within the scope of the invention. No limitation with respect to the specific embodiments disclosed herein is intended or should be inferred.

What is claimed is:

1. A massager comprising:
a handle;
a head attached to the handle and having at least one angled side opposite the handle;
a matrix of at least one positional holes on a side of the head opposite the angled side;
at least one massage tip, insertable into one of the positional holes.

2. The massager of claim 1, further comprising a frictional pad positioned on a side opposite the matrix and one the angled side.

3. A massager comprising:
a rigid handle;
a massage head having at least one positional hole for receiving a massage tip;
a flaccid handle on a side of the head opposite the rigid side; and
at least one massage tip.

4. A massage tip for use with a massager, the tip comprising:
a base post; and
two tip heads, extending above the base post and originating from a middle of the base post;
wherein the base post will rotate within a positional hole in a massager's head.

5. The massage tip of claim 4, further comprising a covering being made from a material chosen from the set of material consisting of: rubber, plastic, vinyl and urethane.

6. The massage tip of claim 4, the two tip heads in an askew relationship to each other.
